(19) United States
(12) Patent Application Publication
(10) Pub. No.: US 2012/0041882 A1
(43) Pub. Date: Feb. 16, 2012

(54) METHOD OF AND COMPUTER PROGRAMME FOR CHANGING AN IDENTIFICATION CODE OF A TRANSACTION AUTHORISATION MEDIUM

(76) Inventors: Wynand Vermeulen, Rotterdam (NL); Erik Vermeer, Rotterdam (NL)

(21) Appl. No.: 13/130,754

(22) PCT Filed: Nov. 24, 2009
(86) PCT No.: PCT/NL2009/000231

§ 371 Date: Oct. 6, 2011

Related U.S. Application Data
(60) Provisional application No. 61/117,598, filed on Nov. 25, 2008.

(30) Foreign Application Priority Data
Nov. 24, 2008 (NL) 1036231

(51) Int. Cl. G06Q 40/00; H04L 9/32

(52) U.S. Cl. 705/75; 705/44

(57) ABSTRACT

The present invention relates to a method of changing an identification code of a transaction authorisation medium, wherein the transaction authorisation medium is designed for authorising transactions of a credit parameter. The identification code is registered by the transaction authorisation medium and by a management server. The transaction authorisation medium is operatively connected to a terminal for changing the identification code, and the terminal is operatively and communicatively connected to the management server via a public telecommunication network. The method comprises the steps of: initiating a transaction; storing the changed identification code in the transaction authorisation medium; and transmitting a changed identification code in encrypted form to the management server via the telecommunication network for carrying out the transaction.

### FIELD OF THE INVENTION

The present invention relates to a method of changing an identification code of a transaction authorisation medium, wherein the transaction authorisation medium is designed for authorising transactions of a credit parameter, and wherein the identification code is registered by the transaction authorisation medium and by a management server.

The present invention further relates to a computer programme for carrying out the method.

### BACKGROUND OF THE INVENTION

The subject matter of the present invention in particular relates to the changing of identification codes, such as personal identification codes (“Personal Identification Numbers”—PIN) of, for example, bank cards, credit cards and smart cards and the like. In view of the confidential nature of the identification code and the consequences for the user when the identification code leaks out and gets in the wrong hands, adequate security measures must be taken when changing such identification codes. It is usual to have the changing of such identification codes take place in a secure environment, which is arranged to prevent the identification code from leaking out at any time.

In the case of modern transaction authorisation media the identification code, such as a PIN code, is usually stored in the transaction authorisation medium itself, such as a bank card, credit card or smart card, for example, as well as at a central location, for example on a server of a financial institution. When the PIN code is to be changed, it must usually be changed in the transaction authorisation medium and on the server of the financial institution simultaneously. If this does not happen, verification of the PIN code after it has been changed may not be possible, and it will not be possible to authorise transactions with the authorisation medium in question. Also in those cases where a PIN code is only stored in the transaction authorisation medium, it is necessary for security reasons to make contact with a central server for changing the PIN code.

In the prior art, changing the PIN code and exchanging data between the transaction authorisation medium and the server of a financial institution generally takes place by means of a closed network which cannot be accessed from the outside, i.e. in a secure environment. In this secure environment an exchange of data can take place between the transaction authorisation medium and the server of the financial institution without there being a risk of the identification code getting in the hands of third parties. A drawback in this regard, however, is the fact that the physical presence of the user and the transaction authorisation medium at the secure environment (for example a bank) of the financial institution is generally required for changing the PIN code in order to make it possible to establish a communication link between the server and the transaction authorisation medium via the closed network. This is time-consuming for users, the more so because at present they are used to doing practically all their banking business from their own environment, for example over the Internet.

### SUMMARY OF THE INVENTION

It is an object of the present invention to solve the above-described problems of the prior art and to provide a method of changing the identification code of a transaction authorisation medium in a secure manner from any environment the user may choose.

The above and other objects are accomplished by the present invention in that it provides a method of changing an identification code of a transaction authorisation medium, wherein the transaction authorisation medium is designed for authorising transactions of a credit parameter, wherein the identification code is registered by the transaction authorisation medium and by a management server, wherein the transaction authorisation medium is operatively connected to a terminal for changing the identification code, and wherein the terminal is operatively and communicatively connected to the management server via a public telecommunication network, wherein the method comprises the steps of: initiating a transaction; transmitting a changed identification code in encrypted form to the management server via the telecommunication network for carrying out the transaction; and storing the changed identification code in the transaction authorisation medium.

The term “credit parameter” is understood to mean a parameter by means of which a balance is indicated, for example. The balance may in particular relate to currency, but it may also relate to, for example, telephone call minutes, savings points, etc.

Within the framework of the present invention, the term “transaction” is understood to mean all the required steps of an action for using, exchanging and changing units of a credit parameter. A transaction may concern the transfer of an amount of money for purchasing a product in a shop, for example, but it may also relate to the use of credit points whose balance constitutes the credit parameter.

The present invention is based on the perception that the infrastructure and systems of the financial institution are designed for processing transactions that have been authorised by means of a transaction authorisation medium. The transactions can be initiated and processed from any desired location, using a network that is accessible to the public. The transaction procedure in that case includes sufficient security measures to prevent improper use thereof as much as possible.

By initiating according to the invention a transaction in relation to a credit parameter for changing the identification code, the actual purpose of the data exchange is masked by means of such a simulated transaction. By simulating a transaction and making use of the data exchange that takes place during the transaction procedure, the identification code can be changed in a secure manner via a network that is accessible to the public.

Additionally, use is made of asymmetric encryption or enciphering of the data exchange in a simulated transaction according to the invention. Thus, the changed identification code can furthermore be effectively prevented from being deciphered by third parties to whom the information has unintentionally become available.

According to a preferred embodiment, one or more of the above-described method steps are carried out by the terminal from where the changing of the identification code by the user takes place. At least one of steps of initiating the transaction, transmitting the changed identification code in encrypted form or storing the changed identification code is in that case carried out by the terminal.

According to another embodiment, the encryption of the data exchange takes place by means of asymmetric public key encryption, more in particular, the following asymmetric public key encryption techniques may for example be considered: RSA (Rivest Shamir Adleman), a Diffie-Hellman key exchange protocol, encryption based on a digital signature algorithm, such as digital signature standard (DSS), ElGamal encryption system, elliptic curve encryption, password-authenticated asymmetric key encryption techniques, Pallier cryptosystem, Cramer-Shoup encryption and Merkle-Hellman encryption.

Since the simulated transaction is primarily carried out for the purpose of changing the identification code, the simulated transaction will according to the invention not have an effect on the credit parameter. In other words, in the case of a simulated transaction with a financial institution, the balance will not be changed and in fact an actual money transaction will not take place. This can be implemented, for example, by forcing the transaction authorisation medium to decline the authorisation of the transaction at all times. After all, a complete money transaction is not intended to take place. The only purpose of the simulated transaction is to change the status of the transaction authorisation medium such that changing the identification code is possible and allowed. Optionally an actual transaction may indeed be carried out, of course, for the purpose of masking the actual purpose of the transaction being carried out, or for charging service costs, for example. Carrying out a transaction to the amount of [symbol] 0.—is theoretically possible, in practice this may present problems, however, in connection with the security checks that are commonly carried out in the case of money transfers.

Changing the identification code in the transaction authorisation medium can take place by providing a change script to the authorisation medium. Such a change script can be generated by the management server, which receives the simulated transaction. Transmitting scripts for performing several functions on the transaction authorisation medium, for example a smart card, is in itself a standard part of an on-line transaction.

The change script can be encrypted by the management server, for example by means of the same encryption techniques as already indicated above in relation to the encryption of the changed identification code.

To ensure that it is clear to the management server, the transaction authorisation medium as well as the user at the end of the method that the changed identification code is known to all three parties (holder/user, authorisation medium, server) and that it is correctly stored, it can be arranged that confirmation messages will be sent, for example at the end of the method. It is possible, for example, to have the terminal confirm to the management server that the storage of the changed identification code in the transaction authorisation medium has successfully taken place. After all, if the changing of the identification code has successfully taken place in the transaction authorisation medium via the change script, the changed identification code must first of all have been correctly received by the management server, and the changed identification code must be known to all parties.

According to another embodiment the method comprises the generation of a rollback script for correcting the identification code in case the method does not proceed correctly. If an error occurs at some point during the method, for example upon receipt of the changed identification code or during the drawing up of the change script, it is important that the same identification code be known to all three parties at the end of the method. A rollback script may be helpful in that case. As soon as an error occurs, the original identification code is put back at the location where the original identification code had already been substituted for the changed identification code, and the occurrence of the error and the carrying out of the rollback script is confirmed to the user. If this situation occurs, no further exchange of the changed identification code will take place.

The skilled person will appreciate that, depending on the change procedure being conducted and the sequence of the method steps, the original identification code must be put back in the transaction authorisation medium or in the management server, or in both. To explain the invention, the present description will start from the situation in which the identification code in the transaction authorisation medium is changed first. Changing the identification code in the management server takes place last, at the end of the change procedure. In this situation the rollback script will in any case put back the original identification code in the transaction authorisation medium. As in this case the changing of the identification code in the management server constitutes the final step of the procedure, putting back the identification code in the management server will generally not be necessary in this embodiment.

As a rule, the rollback script will be generated by the management server. This is not essential, although it is the most pragmatic embodiment for security reasons. In an alternative embodiment, a rollback script is generated in the terminal. In yet another embodiment, rollback scripts may even be generated by the management server as well as by the terminal.

According to a second aspect, the invention provides a computer programme product comprising computer instructions for carrying out a method as described in one or more of the claims on a terminal when the computer instructions are loaded in a computer's working memory.

According to a third aspect, the invention provides a data storage medium, such as a floppy disc, CD ROM, DVD, magnetic tape, memory stick, zip drive, flash memory card, a remote data storage device, semiconductor memory device, programmable semiconductor device, optical disc, magnetic-optical data storage device, comprising a computer programme which comprises computer instructions for carrying out a method as defined in one or more of the claims by means of and by a computer.

### BRIEF DESCRIPTION OF THE DRAWINGS

The invention will be explained in more detail below by means of a description of a few non-limitative embodiments thereof, in which reference is made to the appended drawings, in which:

FIG. 1 discloses a system in which the present invention can be implemented; and

FIG. 2 shows a survey of a method according to the present invention in a system according to FIG. 1.

### DETAILED DESCRIPTION OF THE EMBODIMENTS

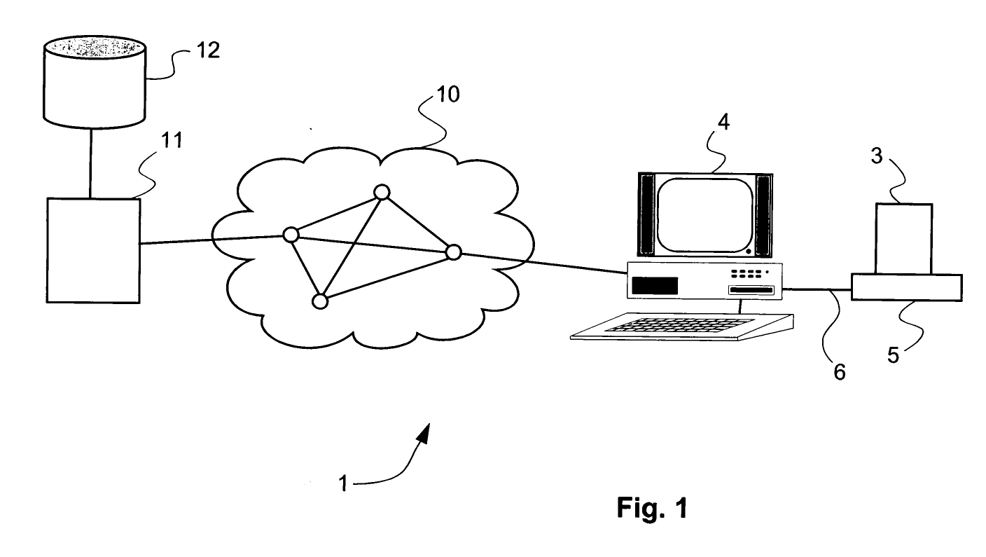

FIG. 1 shows a system 1 in which the method according to the present invention can be implemented. A transaction authorisation medium 3, such as a user's bank card, credit card, smart card, ICC card (ICC—integrated circuit card) or other type of authorisation medium is connected to a terminal 4. The terminal 4, for example a personal computer, forms a user interface by means of which the user is enabled to communicate within the system 1, for example for providing the information required for changing an identification code, for example a PIN (“Personal Identification Number”) code if the transaction authorisation medium 3 is a bank card. The transaction authorisation medium 3 is connected to a terminal 4 via a card reading unit 5, which is physically connected to the terminal 4 via a link 6.

To change the identification code, such as a PIN code, it may be desirable to store the changed identification code on the card as well as in the storage unit 12 that is connected to the bank server 11. Changing the identification code must take place in both units 3 and 11 simultaneously so as to ensure that transactions authorised by means of the transaction authorisation medium 3 can actually be carried out. Changing the identification code on the transaction authorisation medium must therefore include updating the information in the storage unit 12 on the management server side.

The terminal 4 is connected to a public telecommunication network 10, which enables communication between the terminal 4 and the management server 11. Because communication between the management server 11 and the terminal 4 takes place via a public network 10 (for example the Internet), the terminal 4 may be present at any location that provides access to the public telecommunication network 10. The user thus no longer needs to visit a branch of a financial institution, for example, for changing the identification code.

To make it possible to change the identification code via a public network, the method according to the present invention uses simulation of a transaction authorised by the transaction authorisation medium 3. The exchange of confidential information within the framework of the transaction procedure between the terminal 4 and the management server 10 is encrypted by means of an asymmetric encryption technique, such as RSA (RSA is an encryption algorithm which is known per se; the abbreviation RSA is based on the names of the persons who designed it and does not have an meaning as regards content: Rivest, Shamir and Adleman).

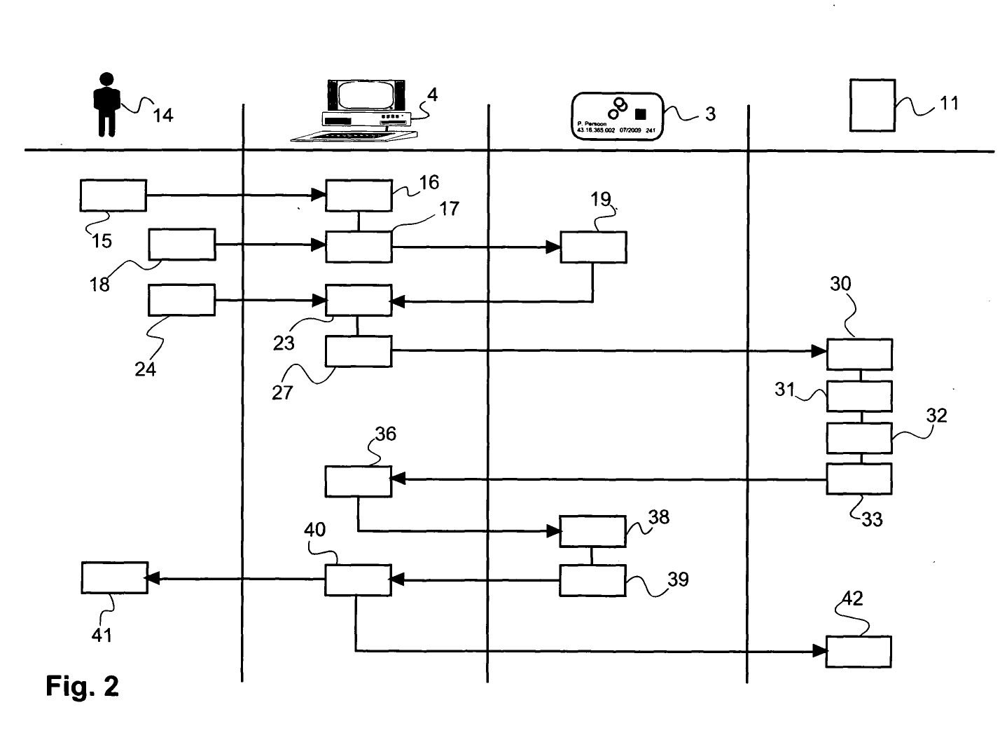

FIG. 2 schematically shows a method according to the present invention. In FIG. 2 it is indicated which method steps are carried out by which units in a system according to FIG. 1. Those skilled in the art will appreciate, however, that some method steps can also be carried out by other units, and that it is possible to deviate from the implementation of the method according to the present invention that is shown herein.

In FIG. 2, a user 14 indicates to the terminal 4 in step 15 that he/she wishes to change his/her identification code. The terminal 4 thereupon initiates a simulated transaction in step 16. The transaction starts with the verification of the original identification code so as to prevent improper alteration of the identification code. In step 17 the terminal 4 thereupon requests the user 14 to enter his original identification code. The user 14 enters the original identification code in step 18, whereupon the terminal 4 presents the original identification code as entered to the transaction authorisation medium 3 for verification. In step 19 the original identification code is verified by the transaction authorisation medium 3, and the result of the verification is fed back to the terminal 4.

It is noted in connection with the above that verification of the user's identity or verification of the authorisation for changing the identification code can also take place in manners different from the manner explained in the foregoing. Not only alternatives such as recognition of a fingerprint, an iris scan or the use of code generators (as known to those skilled in the art) may be considered in this regard, but also adaptation of the identification code may be an option, for example in the case of Internet banking. The user has in that case already logged in via a secure link on the web terminal of his or her bank, for example by means of a code generator.

Subsequently, the user 14 is requested by the terminal 4 in step 23 to enter his changed identification code. In step 24 the user 14 enters his changed identification code. The changed identification code must now be transmitted to the management server 11 for the next part of the procedure. In step 27 the terminal 4 to that end encrypts the changed identification code as entered and forwards the changed identification code, together with all the other transaction data of the simulated transaction, to the management server 11.

Upon receipt of the transaction data in step 30, the management server 11 will find the changed identification code and initiates the procedure for changing the identification code. Depending on the procedure that is conducted, the management server 11 may now store the identification code, but in the present embodiment the storing of the identification code in the management server does not take place until the end of the procedure, as will be explained in more detail below. Although it is common practice, storing the changed identification code in the storage medium is an optional step: after all, for a correct operation it is only relevant that the identification code is stored in the transaction authorisation medium 3. Generally, the identification code will also be stored in the storage medium, and for such systems, by contrast, the changing of the data in the storage medium is important.

After receipt of the transaction data in step 30, the management server 31 may optionally keep a correction log book for changing the identification code. The correction log book stores the original identification code and the new identification code temporarily and registers whether the identification code is successfully changed both in the transaction authorisation medium 3 and in the storage medium 12 during the procedure. It also registers whether the changing of the identification code has been correctly reported to the user 14, so that the latter will not be kept in the dark as to whether or not the identification code has been changed when an error occurs at the end of the procedure. Creating a correction log book and the specific content thereof are optional features of the invention. Such a log book may be kept locally on the management server 11, but according to another possibility both the management server 11 and the terminal 4 keep a correction log book for reversing or not reversing changes that were already made in case errors occur in the change procedure. The creation of a correction log book in the management server 11 takes place in step 31.

In step 32 the management server 11 generates a change script for changing the identification code on the transaction authorisation medium 3 and encrypts the change script for transmission thereof.

In step 33 the generated change script is sent to the transaction authorisation medium 3 in a return message, via the terminal 4. The terminal 4 may be transparent in this communication and be used merely as a “gateway” for forwarding the change script. According to another possibility, the terminal 4 indeed plays an active part in transmitting the change script and, upon receipt of the change script, acknowledges the correct receipt thereof to the management server in step 36 or adapts a correction log book.

In step 38, the original identification code will be changed into the changed identification code upon receipt of the change script by the transaction authorisation medium 3. If the changing of the identification code has taken place correctly, the successful result will be confirmed to the terminal 4 in step 39. Upon receipt of the confirmation, the terminal 4 will send confirmation of the successful result both to the user 14 and to the management server 11 in step 40. In step 41 the user is notified that the change of the identification code has taken place correctly. Upon receipt of this confirmation, the management server 11 will store the changed identification code in the storage medium in step 42 and subsequently close and remove the correction log book.

The embodiments of the invention as described in the foregoing are not intended to be limitative of the invention. The invention may be used for adapting identification codes of transaction authorisation media in general, more in particular of authorisation media such as integrated circuit cards (ICCs) or, in other words, smart cards and chip cards, such as bank cards, credit cards, discount cards, etc. Such transaction authorisation media are designed for authorising transactions of a credit parameter. The term “credit parameter” as used herein is understood to mean a parameter by means of which a balance is indicated, for example. The balance may in particular relate to currency, but it may also relate to, for example, telephone call minutes, savings points, etc. The term “transaction” is understood to mean all the required steps of an action for using, exchanging and changing units of the credit parameter. A transaction may concern the transfer of an amount of money for purchasing a product in a shop, for example, but it may also relate to the use of credit points, whose balance constitutes the credit parameter. The scope of the invention is determined solely by the appended claims.

1. A method of changing an identification code of a transaction authorisation medium, wherein the transaction authorisation medium is designed for authorising transactions of a credit parameter, and wherein the identification code is registered by the transaction authorisation medium and by a management server, wherein the transaction authorisation medium is operatively connected to a terminal for changing the identification code, and wherein the terminal is operatively and communicatively connected to the management server via a public telecommunication network, wherein the method comprises the steps of:
initiating a transaction;
storing the changed identification code in the transaction authorisation medium; and
transmitting a changed identification code in encrypted form to the management server via the telecommunication network for carrying out the transaction.

2. The method according to claim 1, wherein at least one of the steps of initiating a transaction, transmitting the changed identification code in encrypted form and storing the changed identification code is carried out by the terminal.

3. The method according to claim 1, wherein said step of transmitting in encrypted form comprises the step of encrypting by means of asymmetric public key encryption.

4. The method according to claim 1, wherein said step of transmitting in encrypted form comprises the step of encrypting by means of an element of a group comprising RSA, a Diffie-Hellman key exchange protocol, encryption based on a digital signature algorithm, such as digital signature standard (DSS), ElGamal encryption system, elliptic curve encryption, password-authenticated asymmetric key encryption techniques, Pallier cryptosystem, Cramer-Shoup encryption and Merkle-Hellman encryption.

5. The method according to claim 1, wherein the initiated transaction does not have an effect on the credit parameter.

6. The method according to claim 1, wherein the changed identification code is stored in the transaction authorisation medium by providing a change script to the authorisation medium.

7. The method according to claim 1, wherein the changed identification code is stored in the transaction authorisation medium by providing a change script to authorisation medium, by the management server.

8. The method according to claim 1, wherein the changed identification code is stored in the transaction authorisation medium by transmitting a change script to authorisation medium in encrypted form by the management server.

9. The method according to claim 1, further comprising the transmission of a confirmation message to the management server for confirming the successful storage of the changed identification code in the authorisation medium.

10. The method according to claim 1, further comprising the generation of a rollback script for correcting the identification code in case the method does not proceed correctly.

11. The method according to claim 1, further comprising the generation of a rollback script for correcting the identification code in case the method does not proceed correctly, wherein the rollback script is generated by at least one of the terminal and the managment server.

12. A computer programme comprising computer instructions for carrying out the method according to claim 1 on a terminal.

13. A data storage medium comprising a computer programme which comprises computer instructions for carrying out the method according to claim 1 on a terminal.
